(19) United States
(12) Patent Application Publication
(10) Pub. No.: US 2018/0047048 A1
(43) Pub. Date: Feb. 15, 2018

(54) DIGITAL ADVERTISING CAMPAIGN MONITORING SYSTEM, APPARATUS, AND METHOD

(71) Applicant: Gemius S.A., Warsaw (PL)

(72) Inventors: Pawel Mielechowicz, Lomza (PL); Krzysztof Krygiel, Warsaw (PL); Krzysztof Gorski, Warsaw (PL); Marta Sulkiewicz, Warsaw (PL); Piotr Ejdys, Warsaw (PL); Arkadiusz Borowski, Warsaw (PL)

(21) Appl. No.: 15/236,866

(22) Filed: Aug. 15, 2016

(51) Int. Cl. G06Q 30/02; H04L 29/08

(52) U.S. Cl. CPC G06Q 30/0243; G06Q 30/0277; H04L 67/02

(57) ABSTRACT

A method and apparatus for monitoring digital advertising campaigns are disclosed. An example apparatus includes an application monitoring apparatus operating in relation to a web browser on a panelist device. The apparatus includes a database comprising advertisement identification rules configured to identify advertisements within webpage code. The application monitoring apparatus also includes a browser interface configured to analyze webpages accessed by a browser and apply the advertisement identification rules to determine website code that is associated with the advertisement. Conditioned upon detecting an advertisement, the browser interface is configured to copy a portion of the website code that is associated with the advertisement including a creative file source of the advertisement. The browser interface also stores the copied website code to a log file and transmits the log file to a monitoring system.

### BACKGROUND

A typical advertising campaign is designed to convey multiple messages that share a single idea or theme. The messages are conveyed over different media types including television, radio, print, mobile, and web to provide an integrated marketing communication for bringing awareness or promoting superiority of a brand (or company). Some popular advertising campaigns include the “Just Do It.” campaign by Nike®, the “Got Milk?” campaign by the California Milk Processor Board, the “A Diamond is Forever” campaign by De Beers®, and the “The Most Interesting Man in the World” campaign by Dos Equis®. The mere mention of these campaigns triggers memories of the numerous commercials, print advertisements, and digital media. Seemingly, there appears to be a new advertising campaign every week.

Creating a comprehensive adverting campaign is relatively expensive and time consuming. A theme has to be determined that conveys a desired message about the brand. In addition, each message must be painstakingly created to ensure the theme is followed while providing enough differentiation to attract potential consumers' interest without offending or drawing backlash. Further, the messages must be reduced to the appropriate media format, which includes scripting, video production, graphics/layout editing, and multimedia creation. As one can appreciate, companies want to know the effectiveness of their campaigns (i.e., their return-on-investment) to determine whether the campaign should be continued, expanded, or discontinued.

### SUMMARY

The present disclosure provides a new and innovative system, method, and apparatus configured to monitor digital advertising campaigns. As discussed in more detail below, advertising campaigns comprise multiple messages that share a common theme. Determining a reach and ultimate audience of an advertising campaign can be invaluable to the creator of the campaign as well as other interested parties, such as ranking agencies, competitors, and website operators. The example system, method, and apparatus determine the effectiveness of advertising campaigns by collecting panelist browsing behavior information using a monitoring application installed on panelist devices. The monitoring application is configured specifically to use one or more rules, such as ad-blocking rules, to identify advertisements located on webpages. The monitoring application copies a portion of website code associated with the advertisement, which is transmitted to a centralized monitoring server. The example monitoring server is configured to access an ad server identified within the copied code to retrieve a corresponding creative file. The monitoring server analyzes the creative file and corresponding information to determine an associated advertising campaign (if there is any). The monitoring server is also configured to use the advertisement information and/or panelist information to estimate or determine a number of users in a population that viewed each of the advertisements in the campaign in addition to a total number of users that viewed the campaign. The monitoring server may also extrapolate panelist demographic information to the number of determined users to provide an estimated profile of users that viewed an advertising campaign.

In an example embodiment, an advertising campaign analysis apparatus includes a categorization interface connected to panelist devices and ad servers. The categorization interface is configured to receive, from monitoring applications operating on a browser of each of the panelist devices, log files that include copied portions of website code related to advertisements, the monitoring application configured to use at least advertisement identification rule to identify the advertisements on websites. The categorization interface is also configured to analyze the copied website code for addresses of ad servers associated with the advertisements and access the ad servers to obtain copies of creative files associated with the advertisements. The apparatus also includes a categorization processor communicatively coupled to the categorization interface and configured to determine advertisement information associated with each of the creative files. The categorization interface is also configured to determine a product associated with each of the creative files using at least some of the copied website code and the corresponding advertisement information and determine, for each creative file, an advertising campaign for the determined product using at least some of the copied website code and the corresponding advertisement information. The apparatus further includes a user analysis engine configured to determine a number of real users that viewed each of the advertising campaigns by determining a number of real users that viewed each advertisement within the advertising campaign based on a number of instances each advertisement was viewed by the panelists. Moreover, the apparatus includes a display interface configured to display the number of real users that viewed the advertising campaigns.

In another embodiment, an application monitoring apparatus, operating in relation to a web browser on a panelist device, includes a database comprising advertisement identification rules configured to identify advertisements within webpage code, the rules including at least one of a cascading style sheet rule, a uniform resource locator (“URL”) match rule, and an application program interface (“API”) jquery rule. The apparatus also includes a browser interface configured to analyze webpages accessed by a browser and apply the advertisement identification rules to determine website code that is associated with the advertisement. Conditioned upon detecting an advertisement, the browser interface is configured to copy a portion of the website code that is associated with the advertisement including a creative file source of the advertisement. The browser interface is further configured to store the copied website code to a log file and transmit the log file to a monitoring system.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of an example digital advertising campaign monitoring procedure, according to an example embodiment of the present disclosure.

FIG. 2 shows a diagram of an example monitoring environment for acquiring advertisement information, as discussed above in connection with the procedure of FIG. 1.

FIG. 3 shows a diagram of an example monitoring application configured to acquire advertisement information from a webpage, according to an example embodiment of the present disclosure.

FIG. 4 shows a diagram of webpage code related to advertisements stored in a browser console file, according to an example embodiment of the present disclosure.

FIG. 5 shows a diagram of a flow diagram illustrating a procedure to obtain creative files associated with advertisements, according to an example embodiment of the present disclosure.

FIG. 6 shows a diagram of an example ad file configured to store advertisement information, according to an example embodiment of the present disclosure.

FIG. 7 shows a diagram of an example hierarchical tree configured to graphically illustrate how a categorization interface is configured to organize manufacturers, brands, products, and advertising campaigns, according to an example embodiment of the present disclosure.

FIG. 8 shows a diagram of a procedure to determine a number of real users for an advertising campaign, advertisement, and/or website, according to an example embodiment of the present disclosure.

FIG. 9 shows a diagram of estimated cookie (“EC”) data for a specified time period for a specific website (or webpage), according to an example embodiment of the present disclosure.

FIG. 10 shows a diagram of an Lower Bound of Users (“LBU”) analysis performed by a user analysis engine using the same cookie data discussed in connection with FIG. 9, according to an example embodiment of the present disclosure.

FIG. 11 shows a diagram of an example probability matrix used by a user analysis engine to determine a probability that a browser is a target browser for estimating a number of real users, according to an example embodiment of the present disclosure.

FIG. 12 shows a diagram of an example Browser Estimation Algorithm Standard (“BEAST”) calculation that may be performed by a user analysis engine to determine a number of real browsers for estimating a number of real users, according to an example embodiment of the present disclosure.

FIG. 13 shows a diagram of a chart of real browsers of panelists determined by a user analysis engine using the EC, LBU, and BEAST approaches discussed in connection with FIGS. 9 to 12, according to an example embodiment of the present disclosure.

FIG. 14 shows a diagram of a chart of a number of real users for websites using the different approaches discussed in connection with FIGS. 9 to 12, according to an example embodiment of the present disclosure.

FIG. 15 shows a diagram of an example chart that shows a number of real users for an advertising campaign, as determined by a user analysis engine, according to an example embodiment of the present disclosure.

FIGS. 16 and 17 show diagrams of user interfaces showing real users for advertising, according to example embodiments of the present disclosure.

### DETAILED DESCRIPTION

The example system, method, and apparatus disclosed herein are directed to measuring an effectiveness of a digital advertising campaign. In particular, the example system, method, and apparatus are configured to determine advertisements within webpages or social media posts presented to registered panelists. The system, method, and apparatus assign the advertisements to a corresponding brand and/or advertising campaign and use the panelist and advertisement information to determine a number of real users that viewed an advertising campaign. In addition to views, the example method, apparatus, and system are configured to correlate panelist demographic information to advertising campaigns and provide a level of effectiveness of the campaigns by measuring click-throughs.

Reference is also made throughout to digital advertising campaigns. As disclosed in more detail below, a digital advertising campaign provides multiple messages having a common theme in one or more media formats to promote a brand of a product produced by a manufacturer. Digital advertising campaigns can include messages provided through video, static pictures, dynamic pictures, audio, text, hyperlinks, pop-up windows, social media posts, etc. The example system, method, and apparatus are configured to identify digital advertisements within the different media formats and map each message back to the brand. After advertisements are associated with respective brands, the example system, method, and apparatus are configured to analyze the advertisements associated with each brand to determine which of the advertisements are associated with the same advertising campaign.

Reference is also made throughout to panelists and consumers. As disclosed herein, consumers are targeted end-users of advertising campaigns. The purpose of most advertising campaigns is to convince end-users to purchase (or continue the use of) a product or service. As provided herein, consumers are end-uses that have viewed an advertising campaign and may take steps to purchase an advertised product and/or service.

Panelists are end-users that agree to be monitored by a tracking and monitoring service. Panelists agree for the tracking and monitoring service to install one or more tracking applications on their computing devices to collect computing activity. In the example disclosed herein, panelists agree to have a plug-in application installed in one or more web browsers operating on a panelist device. The plug-in application is configured to acquire information regarding browsing behavior of the panelist including websites visited and advertisements displayed on each webpage. The plug-in application is also configured to identify social media websites and determine advertisements within posts, tweets, etc. In addition to enabling their computing activity to be monitored, panelists provide demographic information, which is later used downstream to correlate monitored activity with demographics for a plurality of panelists. Demographic information may include, for example, age, gender, race, ethnicity, nationality, primary language, geographic location, religious affiliation, sexual orientation, marital status, relationship status, children status, education level, income level, occupation, hobbies, and/or personal preferences (e.g., sports teams, dining, shopping, etc.).

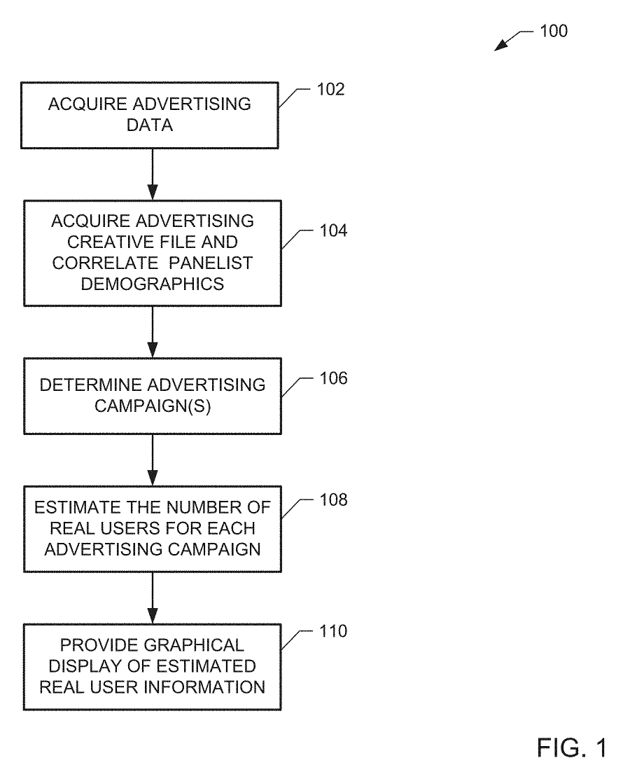

FIG. 1 shows a diagram of an example digital advertising campaign monitoring procedure 100, according to an example embodiment of the present disclosure. The example procedure 100 shows an overview of the different steps performed by the example system, method, and apparatus disclosed herein to determine the effectiveness of an advertising campaign by estimating the number of end-users that viewed (and/or interacted) with the different messages. Although the procedure 100 is described with reference to the flow diagram illustrated in FIG. 1, it should be appreciated that many other methods of performing the steps associated with the procedure 100 may be used. For example, the order of many of the blocks may be changed, certain blocks may be combined with other blocks, and many of the blocks described are optional. Further, the actions described in procedure 100 may be performed among multiple devices including, panelist devices, categorization servers, and/or user processing servers.

The example procedure 100 of FIG. 1 begins when plug-in applications operating on panelists devices are configured to detect digital advertisements on webpages and/or social media sites. The plug-in applications are configured to acquire information about the advertisements including source and creative identifying information (block 102). The plug-in applications may combine the advertisement information with browsing information and transmit this information to a categorization server. This information provides data regarding which advertisements were presented to a panelist.

In a second step, as described in more detail below, the categorization server is configured to use source and creative identifying information to access the advertising creative files from appropriate ad servers and/or content servers (block 104). For instance, content servers that display advertisements in a webpage or other content often access files (e.g., creative files) received from specified ad servers. The files contain the advertisements that are shown within the content or webpage provided by the content servers. The example categorization server disclosed herein obtains an IP address and advertisement identifier from the source and creative identifying information to obtain the corresponding creative file from the ad server.

In a third step, the example categorization server is configured to analyze the creative file in connection with the information from the panelists to determine a corresponding brand for each of the advertisements (block 106). After determining the brand, the categorization server is configured to determine whether the advertisement is part of an advertising campaign using, for example metadata, audio signature analysis, and/or video signature analysis. The categorization server groups together different advertisements associated with the same campaign. In addition, the categorization server correlates demographics of panelists that viewed each of the advertisements. At this point, the categorization server has matched which groups of panelists (based on demographics) have viewed which advertisements.

In a fourth step, an example user processing server is configured to estimate or extrapolate the panelist information to a total number of real users (block 108). For instance, the monitoring and tracking service may register 5,000 panelists for a total population of 800,000 people. Assuming the demographics of the panelists closely resemble the total population, an estimated number of real users to each website can be determined in addition to the number of real users exposed to a digital advertising campaign.

In a fifth step, a statistical analysis server is configured to create graphical representations of the estimated real user data for third-parties (block 110). The graphical representations may include charts, tables, etc. that summarize the data regarding the estimated real users (and/or panelists). The statistical analysis server is configured to enable a third-party to filter the data based on different criteria including, time period, industry, brand, advertisement publisher, advertisement type, sales model, etc. The statistical analysis server may also provide information regarding advertisement or webpage impressions, advertisement in-screen time, and real impact as indicated by click-throughs or more substantive interaction.

It should be appreciated that the above described procedure 100 enables the effectiveness of digital advertisement campaigns to be tracked though viewership across thousands of websites. As mentioned above, potions of websites are designated for advertisements. An intermediary company may control the ad-space for a group of websites, which could include hundreds to thousands of different websites. A manufacturer (or promoter) pays the intermediary company to display one or more advertisements for an advertising campaign to some of all of the websites under management. Further, the manufacturer may pay other intermediaries that control ad-space on other websites and/or websites themselves to display the advertisements. The end-result is that different messages for an advertising campaign may be displayed on some or all of a large number of websites. Attempting to gauge effectiveness of an advertising campaign by monitoring traffic at specific websites is virtually impossible given the large number of websites that would have to be tracked. Some high-traffic websites may be tracked, however this provides an incomplete picture. The example method, system, and apparatus disclosed herein determine the effectiveness of an advertising campaign through the eyes of the end-users (via the panelists), which is the intended audience of the advertisement messages to begin with.

In contrast to the digital advertising campaign monitoring disclosed herein, many known media and consumer monitoring companies attempt to determine a campaign's reach and effectiveness through either consumer monitoring, website (or app) tracking, or advertisement tracking. On the consumer side, tracking software operating in the background of a computer or smartphone records websites visited by a user. The tracking software may also identify ads within a webpage and record user click-throughs. While the tracking software may provide information about ads on a webpage, this tracking software cannot determine which ads are part of larger campaigns or determine information related to the generation of the advertisement.

Regarding website tracking, some known monitoring companies may be enlisted to track website traffic. This includes tracking page views, which is when any page is loaded by a user. This also includes determining unique visitors based on Internet Protocol (“IP”) addresses of the accessing user device (e.g., smartphone) and a cookie stored on a browser of the user device that is accessing the website. Page-scripts and/or web crawlers may be used to identify how consumers have interacted with the page, including ad click-throughs. However, the known website traffic tracking is local to the one website. As discussed above, an advertising campaign may be displayed on thousands of websites. Monitoring only one (or a few) websites may provide limited visibility regarding the reach of a particular ad. Further, the known website monitors are specific to the website and are not concerned with determining how a particular ad relates to a complete campaign.

Some web or digital ads may include a video ad serving template (“VAST”) that specifies how an ad is to be displayed or played from an ad server. The VAST enables impression counting to being when the video is played (rather than accidently selected), event tracking (e.g., first quartile viewing, midpoint viewing, complete viewing, average view time/rate, error count, video length, pause, rewind, mute, collapse, full screen, view-through rate, video skipped rate, etc.), and website or app locations where a video ad is served. While this information provides insight into how a video (or other digital) ad is viewed, it does not provide information regarding about the demographics of the end-user or an analysis of the ad within a complete campaign.

### Digital Campaign Advertising Monitoring Embodiment

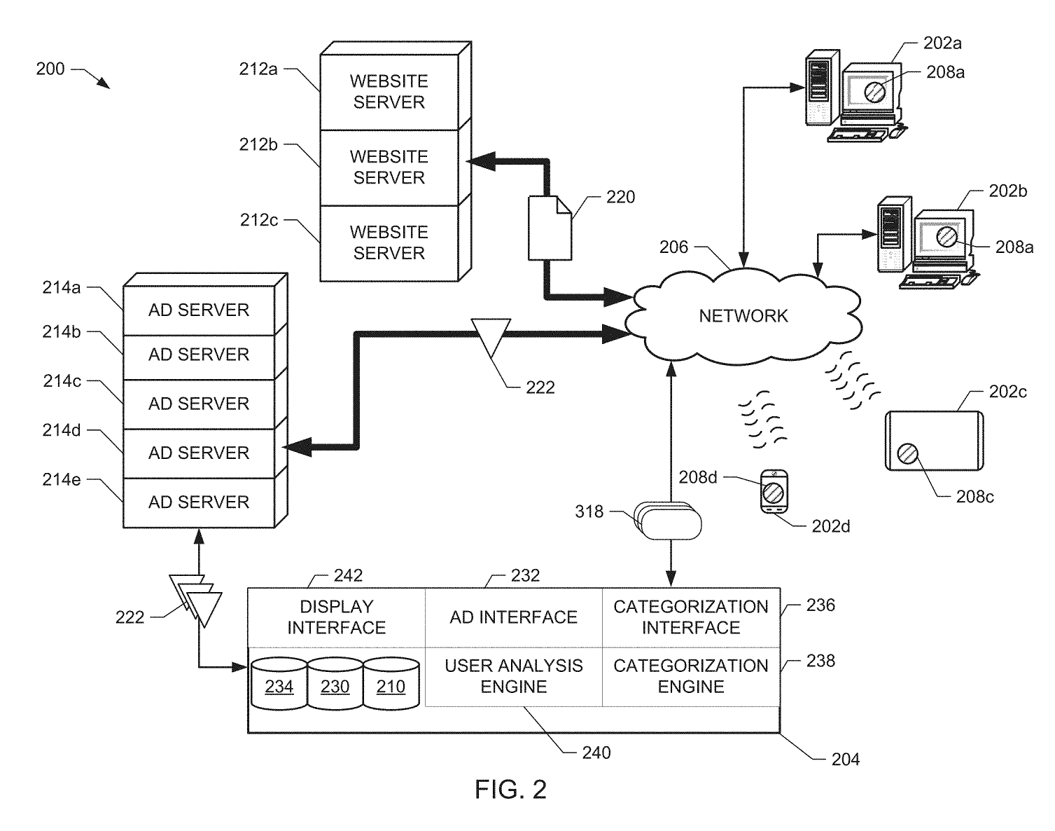

FIG. 2 shows a diagram of an example monitoring environment 200 for acquiring advertisement information (including webpage code related to advertisements on webpages), as discussed above in connection with step 102 of the procedure 100 of FIG. 1. The example monitoring environment 200 includes panelist devices 202 communicatively coupled to an ad campaign monitoring server 204 via a network 206 (e.g., the Internet). The panelist devices 202 may include any type of computing device including, for example, desktop computers (e.g., devices 202a and 202b), tablet computers (e.g., device 202c) and/or smartphones (e.g., device 202d). The panelist devices 202 may also include laptop computers, servers, workstations, smart-watches, smart-eyewear, personal digital assistants (“PDAs”), etc. The panelist devices 202 may connected to the network 206 via any wired and/or wireless connection including for example, 4G cellular, 5G cellular, Wi-Fi, wide area network, Ethernet, etc. While FIG. 2 shows the four panelist devices, it should be appreciated that the environment 200 may include hundreds or thousands of panelist devices.

The panelist devices 202 each include a monitoring application 208 configured to track and/or monitor computing activity. Specifically, the example monitoring application 208 is configured to apply one or more rules to detect digital advertisements on webpages and/or within social media feeds. After detecting an advertisement, the monitoring application 208 is configured to copy information related to the advertisement. In some instances, the monitoring application 208 is configured to copy, to a log file, HyperText Markup Language (“HTML”) code from the webpage that is related to the advertisement. The monitoring application 208 may also store to the log file information related to displayed webpages, information related to which portions of a webpage or which advertisements are viewed and/or interacted by a panelist, and/or information related to other computing activity, such as other programs operating on the panelist device 202.

The example monitoring application 208 may be transmitted to the panelist device 202 after a panelist has registered with the monitoring server 204. For instance, a panelist may register by accessing a webpage hosted by the monitoring server 204 and completing a web-form with demographic information. Such information may include, for example, age, gender, race, ethnicity, geographic location, nationality, primary language, religious affiliation, sexual orientation, marital status, relationship status, children status, education level, income level, occupation, hobbies, and/or personal preferences (e.g., sports teams, dining, shopping, etc.). The monitoring server 204 is configured to store the demographic information for each panelist to a panelist database 210. The monitoring server 204 may also assign a panelist identifier to the appropriate demographic information. As discussed below, the panelist identifier is used to correlate demographic information to logged computing activity.

In addition to demographic information, the panelist may provide registration information related to how the monitoring application 208 is to be installed and/or operate. For instance, the monitoring server 204 may be configured to enable a panelist to select which types of web browsers the monitoring application 208 is to track. The monitoring server 204 may also be configured to enable a panelist to select which device(s) is to receive the monitoring application 208. The monitoring server 204 may further enable the panelist to select or specify a number of different users that are to be tracked on the selected devices.

After a panelist has registered, the example monitoring application 208 is configured to transmit one or more messages (containing code for installing the monitoring application 208) to the specified panelist device 202. Reception of the messages at the device 202 may cause the monitoring application 208 to self-install. In other instances, the messages may provide instructions for the panelist to follow to install and/or configure the monitoring application 208.

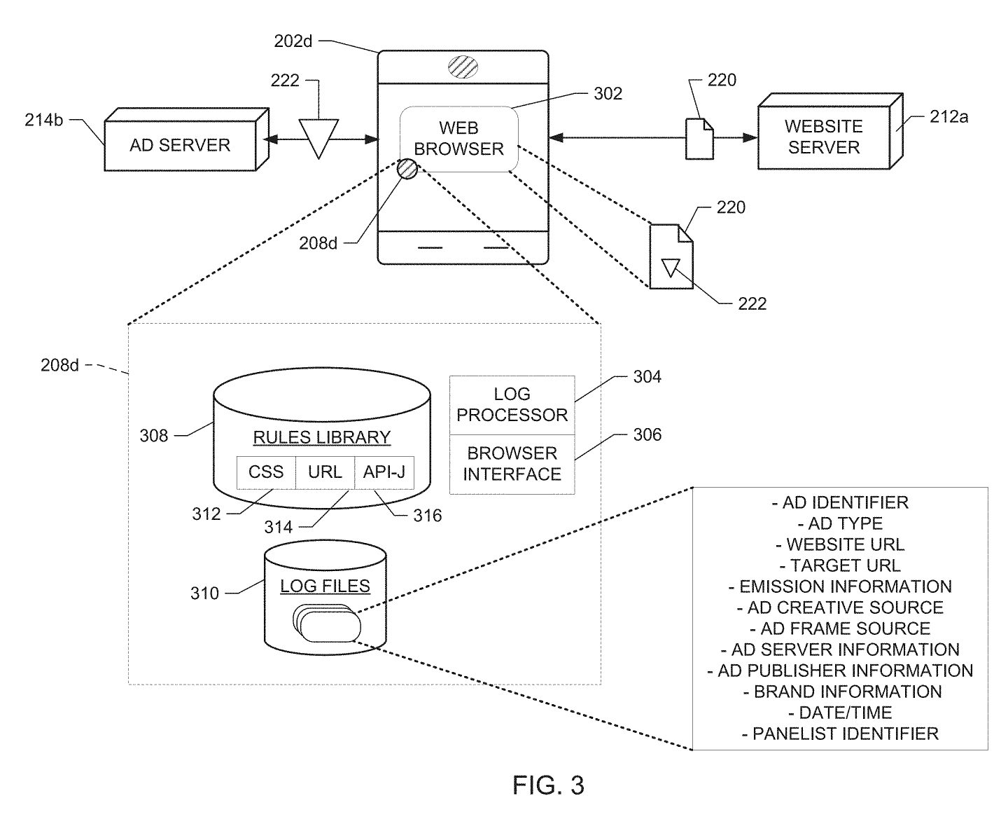

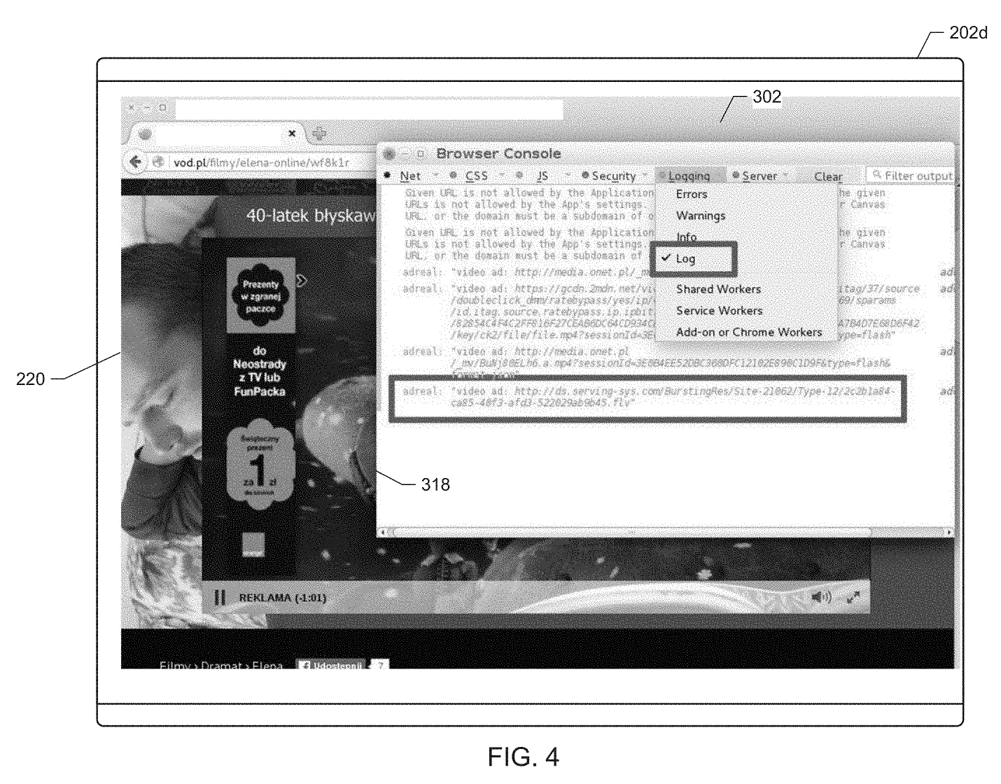

The example monitoring application 208 is configured to operate in the background of the device 202 and/or webpages. In some instances, the monitoring application 208 may be a stand-alone application configured to read content (e.g., HTML code) of webpages rendered at the panelist device 202. In other instances, the monitoring application 208 may be a plug-in application or script configured to operate on one or more specified web browsers. In these other instances, the monitoring application 208 is configured to read and analyze webpage content for digital advertisements (among other specified criteria). Operation of the monitoring application 208 is discussed in further detail below in connection with FIGS. 3 and 4.

The example monitoring environment 200 also includes a plurality of website servers 212 and ad servers 214. The website servers 212 are configured to host websites accessible to the panelist devices 202 via web browsers. The websites may include virtually any type of website including news sites, social media sites, media sites, gaming sites, etc. Each website includes one or more webpages with text and multimedia. The webpages may also include locations for advertisements. The example ad servers 214 are configured to provide the ad content (e.g., the advertisements) for webpages being accessed by web browsers on the panelist devices 202. It should be appreciated that each ad server 214 and web site server 212 has a separate connection to the network 206. For ease of viewing, FIG. 2 shows the multiple connections between the network 206 and the servers 212 and 214 as a single connection.

A webpage includes specifically designed areas for advertisements that conform to industry customs and standards. For example, most advertisements are to be separated from webpage content so as to be distinguishable from the content. This may include placing advertisements along page margins or in-line separated by space. The creator of the webpage does not know which advertisements are to be displayed. Instead, placeholders are created in the webpage for locations where advertisements are to appear. The placeholders may include a video player, an empty graphic box, an ad slot defined by an empty space, etc. In addition, the placeholders include HTML code that includes a hyperlink to a specific location at one of the ad servers 214.

Each ad server 214 is configured to host advertisements (e.g., creative files, images, etc.) that are selected for placement in the empty advertisement slot(s) in the webpage. The ad server 214 receives an indication of which placeholder is being accessed and determines which advertisements are designated for that slot. The ad server 214 may randomly select one of the appropriate advertisements. Alternatively, the ad server 214 may select the appropriate advertisements based on one or more browser cookies, which are obtained through interaction with the panelist device 202. For instance, some advertisements may have one or more rules or criteria for selection based on whether certain data is present within one or more browser cookies.

FIG. 3 shows a diagram of an example embodiment of how the monitoring application 208 of FIG. 2 acquires advertisement information from a webpage, according to an example embodiment of the present disclosure. In this example, a web browser 302 (e.g., a web browsing application) operating on the panelist device 202d accesses a website (e.g., transmits a page request) that is hosted by the website server 212a. In response, the website server 212a transmits a website page 220 with content HTML and ad HTML. The web browser 302 executes the content HTML and ad HTML. Execution of the ad HTML causes the browser to transmit an ad request to the ad server 214b (e.g., a publisher ad server). The example ad server 214b determines which advertisement is to be displayed (using any available selection rules) based on the request and accordingly transmits a corresponding ad file 222 (e.g., a creative file). Before the advertisement is selected, the ad server 214b may read browser cookies stored in relation to the web browser 302 on the panelist device 202d to determine, for example, previous websites visited, products/brands browsed, etc. In some instances, the ad server 214b determines if the browsing history within the cookies match the specified criteria to determine which advertisement is selected. The example web browser 302 receives the advertisement from the ad server 214b in the ad file 222. The web browser then inserts or renders the ad file 222 for display within the webpage 220.

In another example, before a video creative file 222 (such as a FLV, Webm, mp4, 3gp, etc.) is served onto webpage 220, the video player of the web browser may be already playing editorial content on the page. The video serves directly into the player. Rich media creatives may be played differently. Before a rich media creative file 222 is served onto webpage 220, the ad slot is an empty space. The creative file 222 (such as a FLV, Webm, mp4, 3gp, etc.) is served directly onto the webpage 220, and a video is embedded in the small web format (“SWF”). In other examples, the creative file 222 may include images, flash animation, audio, and/or text.

The example monitoring application 208d is configured to operate as a plug-in of the web browser 302 and operate in the background to identify advertisements on a webpage 220. In other embodiments, the monitoring application 208d may operate as a browser add-in and/or a browser extension. Alternatively, the monitoring application 208d may be a standalone application configured to read webpages rendered by the web browser 302. It should be appreciated that the web browser 302 may comprise any web browser including the Firefox™ browser, the Chrome™ browser, Internet Explorer™, and the Opera™ browser.

FIG. 3 shows that the monitoring application 208 may include a log processor 304, a browser interface 306, a rules library 308, and a log file database 310. It should be appreciated that each of components 304 to 310 may include computer-readable instructions, which when executed, cause a processor of the panelist device 202d and/or the web browser 208d to perform defined steps or actions. Further, the library 308 and/or the database 310 may include or be assigned portions of memory of the panelist device 202d. While the components 304 to 310 are show as comprising the monitoring application 208d, it should be appreciated that the monitoring application 208d may be implemented by fewer, additional, or different components collectedly configured to detect and record information related to advertisements located on browsed webpages or other web content.

The example browser interface 306 is configured to recognize advertisements on webpages 220 using one or more defined advertisement identification rules within the rules library 308. The rules may include, for example, cascading style sheet (“CSS”) rules 312, URL match rules 314, and/or application program interface (“API”) jquery rules 316. The rules 312 to 316 may include rules created by third-parties for the purpose of ad-blocking, webpage traversal, webpage manipulation, and webpage event handling. For example, the jquery rules 316 may include JavaScript rules provided by jquery.com (e.g., at https://api.jquery.com/category/traversing/). In another example, ad-blocking rules may include rules created by Ad Block Plus™. The CSS rules 312 may include CSS selectors or patterns for identifying particular portions of HTML related to advertisements. The example rules 312 to 316 may also include rules for comparing browser traffic after a webpage is loaded to identify ad request and response messages.

In some instances, the example monitoring application 208 is configured to communicate with the monitoring server 204 to receive new and/or updated rules. For instance, advertisers or operators of ad servers 214 constantly attempt to develop HTML code that circumvents ad-blocking applications. This includes attempting to disguise ad HTML code as webpage content HTML code. In response, ad-blockers revise the rules for detecting ads. The monitoring server 204 is configured to receive updates of new and/or updated rules and propagate these updates to the monitoring applications 208 within the field. Further, the monitoring server 204 may develop proprietary rules for identifying advertisements and transmit these rules to the monitoring applications 208.

The example browser interface 306 is configured to read the HTML code of the webpage 220 and compare each line of code to the rules 312 to 316. The browser interface 306 is also configured to compare browser traffic to the rules 312 to 316. Comparing the rules 312 to 316 to the HTMl code may include comparing HTML labels and/or fields to lists of labels and/or fields within the rules 312 to 316. Comparing may also include searching for key terms, such as ‘ad’, ‘video’, ‘brand’, etc. within the HTML code. Comparing may further include searching for HTML code that includes a target URL to known ad servers or a landing page URL. Responsive to the code or traffic matching at least one rule, the browser interface 306 is configured to copy at least a portion of the HTML code related to the code identified as being an advertisement. In some instance, the browser interface 306 is configured to acquire simplified HTML code related to the advertisement.

The example browser interface 306 of FIG. 3 is configured to provide the copied HTML code to the log processor 304, which is configured to store the HTML code to a log file 318. In some instances, the log file 318 may include a browser console file. For instance, FIG. 4 shows a diagram of HTML code related to advertisements stored in a browser console file, according to an example embodiment of the present disclosure. In this illustrated example, the panelist device 202d is displaying webpage 220 in a web browser 302. The browser interface 306 identifies HTML code related to an advertisement and causes the log processor 304 to store a copy of the code to the browser console (e.g., log file 318). As illustrated in FIG. 4, the log file 318 includes a label (i.e., ‘video ad’) in conjunction with a URL to the ad server. It should be appreciated that the browser console log file 318 is shown for illustrative purposes. Generally, the log file 318 is not displayed to a panelist while viewing webpages.

Returning to FIG. 3, the log processor 304 is configured to store the log file 318 to the log file database 310. The log file 318 may be stored with previously created log files that correspond to previous browser sessions, previous days, other panelists, and/or other web browsers. The example log processor 304 is configured to transmit the log files 318 to the monitoring server 204 periodically, as shown in FIG. 2. For instance, the log processor 304 may transmit a log file at the end of a browsing session, daily, weekly, etc.

In addition to determining an ad type and ad server URL (e.g., source of advertisement creative file), the example browsing interface 306 and/or the log processor 304 may determine and store other advertisement information, or more generally, computing activity to the log file 318. For example, the browser interface 306 and/or the log processor 304 may determine and/or store an advertisement identifier to the log file 318. In some instances, the ad server URL may serve as the identifier. Further, the browser interface 306 and/or the log processor 304 may determine and store the website URL of the website 220 showing the advertisement, the target URL or landing page associated with the advertisement, a source of advertising frames (and corresponding frame description), and/or advertisement emission information (e.g., emission information related to the Google® display network). The browser interface 306 and/or the log processor 304 may determine and store information related to a publisher of the advertisement, and/or a manufacturer/brand/product associated with the advertisement. Additionally, the browser interface 306 and/or the log processor 304 is configured to store a panelist identifier (e.g., a unique identifier assigned to the panelist and/or the monitoring application 208) to the log file 318 to enable the recorded advertisement information to be associated with demographic information of the panelist, which is stored at the monitoring server 204. The browser interface 306 may further determine a date/time the advertisement was viewed, which may enable the monitoring server 204 to later correlate the advertisement viewing with data within a browser cookie or determine unique views or impressions of the advertisement. The browser interface 306 may also determine a browser type and/or version.

The example browser interface 306 of FIG. 3 is accordingly configured to recognize display advertisements including, for example, display ads, video ads, search ads, social media ads, rich media ads that are emitted on the web browser 302. This includes the browser interface 306 being configured to search social media feeds and posts for advertisements. Further, the browser interface 306 is configured to recognize information related to mediaplans of video ads through an analysis of XML/VAST files. The browser interface 306 is also configured to acquire simplified HTML including creative file source information, creative target URLs, and creative file frame and source information.

The browser interface 306 may also record how a panelist interacts with an advertisement, such as whether a panelist selects an advertisement to be redirected to a webpage associated with the advertisement. The browser interface 306 may also determine whether the advertisement was viewable by a panelist or hidden (or partially hidden) by another window. For instance, the browser interface 306 may determine a screen placement (e.g., coordinates) of the advertisement on the panelist device 208d and determine if other windows are open that have similar screen placement. This also includes matching recognized advertisements with specific placement on the webpage 220 including size and formatting rules. Further, the browser interface 306 may determine how long an advertisement was viewable (and/or how much of advertising video was played) before a panelist continued scrolling down. Moreover, the browser interface 306 may record whether a panelist replayed or otherwise interacted with an advertisement.

In some embodiments, the log processor 304 may also store browser cookies to the log file database 310. The log processor 304 may transmit the browser cookies in connection with the log files 318. Such information may be used by the ad campaign monitoring server 204 to determine or estimate a number of real users that viewed an advertising campaign based on information from the panelist samples. For example, the browser cookies may be used to determine how frequently a panelist visits particular website and/or how often the panelist uses the particular browser.

As mentioned above, the log processor 304 is configured to transmit periodically one or more log files to the ad campaign monitoring server 204. FIG. 2 shows the monitoring server 204 receiving log files 318 from the monitoring applications 208 operating on the respective panelist devices. The monitoring server 204 is configured to store the log files 318 to database 230. In this manner, the example monitoring server 204 obtains information related to all of the advertisements displayed to panelists regardless of which websites were visited.

In some embodiments, the monitoring server 204 is configured to convert the HTML code in the log files 318 to one or more database ad identifiers. For example, an ad server URL included within copied HTML code may be used as an identifier for the respective advertisement. The monitoring server 204 may also read labels and/or fields of the HTML code to extract advertisement information, which is then stored as searchable text within the log file 318, or more generally, the database 210.

### Creative File Acquirement Embodiment

The example ad campaign monitoring server 204 of FIG. 2 is configured to use the advertisement information, browsing information, cookies, etc. from the monitoring applications 208 to obtain creative files associated with identified advertisements, as discussed above in connection with step 104 of the procedure 100 of FIG. 1. Oftentimes the ad HTML code copied from a web site does not include much information about the advertisement other than a link to a location on an ad server 214. In these instances, the creative file contains information about the advertisement including, for example, publisher information, emission information, first publication date, manufacturer/brand/product information, etc. However, having the monitoring application 208 copy each webpage advertisement would consume significant storage space on the panelist device 202 and use significant network bandwidth transmitting the creative files, which may be relatively large. Further, each monitoring application 208 may copy instances of the same advertisement, which means the monitoring server 204 would receive multiple copies of the same advertisement. As one can appreciate, this consumes excessive processing power unnecessarily.

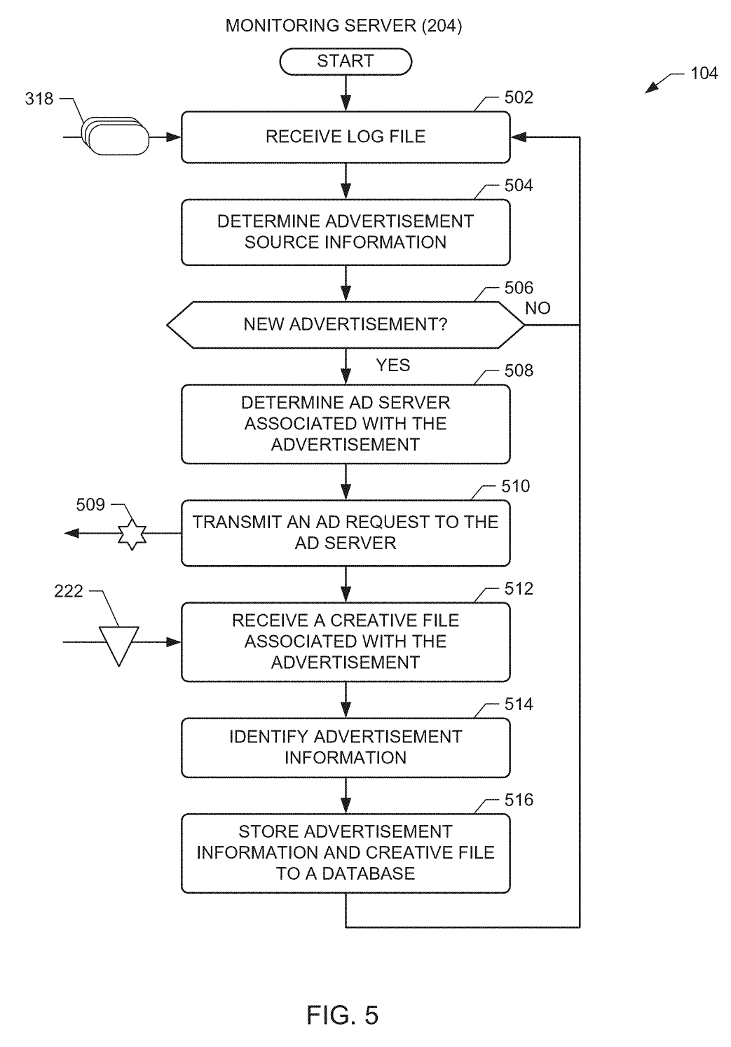

The example ad campaign monitoring server 204 is configured to determine advertisements viewed by panelists and download one copy of each of the advertisements, which is stored in the database 230. FIG. 5 illustrates a flow diagram showing example procedure 104 to obtain creative files associated with advertisements, according to an example embodiment of the present disclosure. Although the procedure 104 is described with reference to the flow diagram illustrated in FIG. 5, it should be appreciated that many other methods of performing the steps associated with the procedure 104 may be used. For example, the order of many of the blocks may be changed, certain blocks may be combined with other blocks, and many of the blocks described are optional. For instance, the procedure 104 may omit the step of determining if an advertisement has already been downloaded.

The example procedure 104 of FIG. 5 begins when the ad interface 232 determines that one or more log files 318 have been stored to the database 230 (or received from the monitoring applications 208) (block 502). The ad interface 232 is configured to read and/or analyze each log file to search for advertisement information that is indicative of a source of the advertisement (e.g., a URL directed to a creative file stored on an ad server 214) (block 504). This may also include determining an identifier of the advertisement.

The example ad interface 232 is configured to determine if the advertisement is new to the monitoring server 204 (block 506). In other words, the ad interface 232 is configured to determine whether a creative file for the advertisement has already been downloaded. To make this determination, the ad interface 232 is configured to compare, for example, the ad identifier and/or the URL to ad identifiers and/or URLs of creative files already downloaded. If there is a match, the ad interface 232 determines that another creative file does not need to be downloaded and returns to processing newly received log files (block 502).

If there is not a match at step 506, the example ad interface 232 is configured to identify the ad server 214 that is associated with the ad (block 508). This can include, for example, identifying an ad server located at an address specified by a URL. The ad interface 232 then transmits an ad request message 509 to the identified ad server 214 (block 510). The ad request message 509 may include for example, an ad request directed to the identified URL located at the ad server 214. The message may also include an identifier of the advertisement, in instances where the URL may be associated with more than one advertisement. After transmitting the message 509, the ad interface 232 receives a creative file 222 associated with the requested URL (block 512).

The ad interface 232 then reads and/or analyzes the creative file 222 to determine advertisement information such as publisher, publication date, publication source, manufacturer/brand/product (block 514). In some instances, the advertisement information may be stored within metadata associated with the creative file 222. In other instances, the ad interface 232 is configured to read text of the creative file 222 and/or analyze video/audio of the file. For example, the ad interface 232 uses speech recognition software to analyze audio to determine brand, product, slogan, etc. associated with the advertisement. In another example, the ad interface 232 uses image recognition software to identify trademarks, brands, and/or products within video or display ads.

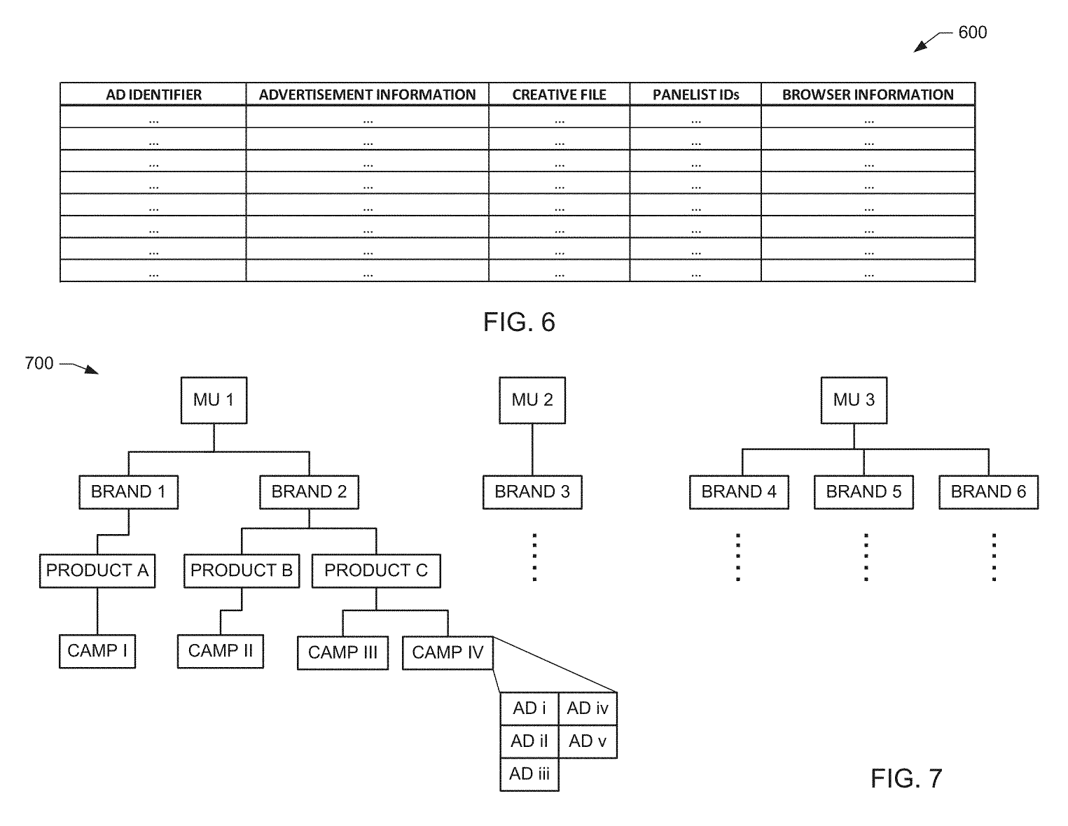

The example ad interface 232 then stores the identified or acquired advertisement information and/or the creative file 222 to the database 230 (block 516). FIG. 6 shows a diagram of an example ad file 600 configured to store advertisement information. The example ad file 600 is configured to store a compilation of information from multiple log files of different panelists for each different advertisement. The ad file 600 includes an ad identifier, which is used to distinguish each advertisement. The ad identifier may be assigned by the monitoring server 204 and/or determined from information related to an advertisement. The advertisement information includes information provided by the monitoring applications 208 and determined by the ad interface 232. In this instance, advertisement information may only include information related to the advertisement itself (such as publisher, ad server information, brand, target URL). Information about the webpage the advertisement was displayed within and panelist browsing behavior may be stored within the browser information field. The ad file 600 may also include a link to the creative file. In other examples, the creative file may be stored to the ad file 600. The ad file 600 also includes a field that lists the identifiers of panelists that viewed the advertisement.

As mentioned above, the panelist identifier may be included within the log file 318. The panelist identifier references demographic information related to the panelist. Inclusion of the panelist identifier within the ad file 600 enables demographic information of each panelist to be associated with the advertisement. For example, the monitoring server 204 may use the ad file 600 to provide demographic statistics for each advertisement in addition to a summary of how different panelists interacted with, or more generally viewed, the advertisement.

Returning to FIG. 5, after storing the advertisement information to the ad file 600, the ad interface 232 is configured to return to processing newly received log files (block 502). In some alternative embodiments, if there is a match at step 506, the ad interface 232 may still access the ad server to determine if the creative file 222 has been updated or has a different publication date than the already stored creative files. For instance, some advertisements may be updated or edited based on initial feedback. If there is a difference in publication date, version number, etc., the ad interface 232 is configured to download the updated version of the creative file and process as discussed above in connection with steps 508 to 516.

### Advertisement Categorization Embodiment

The example ad campaign monitoring server 204 of FIG. 2 is also configured to determine whether advertisements are part of a larger ad campaign, as mentioned above in connection with step 106 of the procedure 100 of FIG. 1. Specifically, the monitoring server 204 is configured to include a categorization interface 236 and a categorization engine 238 to match an advertisement to an advertising campaign.

The example categorization interface 236 is configured to determine relationships between manufacturers, brands, and/or products. FIG. 7 shows a diagram of an example hierarchical tree 700 configured to graphically illustrate how the categorization interface 236 is configured to organize manufacturers, brands, products, and advertising campaigns. The categorization interface 236 may store and/or manage the hierarchical tree 700 from database 234 of FIG. 2. For easy of viewing, only a limited number of manufactures, brands, and products are shown. However, it should be appreciated that the hierarchical tree 700 may include tens to hundreds of manufacturers with their corresponding brands and products. Further, while the organization is shown as a tree-structure, in other instances the organization may be based on a flat-structure, SQL database, or non-SQL database.

In some examples, the categorization interface 236 is configured to create the hierarchical tree 700 for virtually all companies. Then, as advertisements are identified, the categorization engine 238 is configured to determine which manufacturer/brand/product is associated with the advertisement. In other examples, the categorization interface 236 is configured to determine a manufacturer/brand/product of each advertisement stored in the database 230. The categorization interface 236 is configured to determine if a manufacturer/brand/product already exists for the advertisement and accordingly adds (or otherwise corresponds) the advertisement to the product. However, if any of the manufacturer, brand, or product is not already created within the hierarchical tree 700, the categorization interface 236 is configured to fill in the tree 700 with the missing information. For instance, the categorization interface 700 may determine that an advertisement is associated with MU1, Brand 2 and Product C. However, at the time, no Product C exists in the hierarchical tree 700. The categorization interface 236 accordingly creates a new branch under Brand 2 of MU1 for Product C. In other instances, the categorization interface 236 is configured to transmit an alert message to administrative personnel requesting that the Product C is to be added under Brand 2, or more generally, that there is no Product C within the hierarchical tree 700.

To determine a manufacturer/brand/product, the example categorization interface 236 is configured to analyze the advertisement information stored in the ad file 600. For instance, the ad interface 232 determines manufacturer/brand/product from metadata of a creative file, text search of the creative file, audio/video recognition of the creative file, and/or based on a target URL. In some embodiments, the ad interface 232 stores or labels the appropriate advertisement information as ‘manufacturer’ ‘brand’, and ‘product’. In other examples, the categorization interface 236 is configured to compare the advertisement information to a directory of known manufacturers, brands, and products to determine this information.

In this illustrated example, the categorization interface 236 is configured to list manufacturers (e.g., General Motors®, PepsiCo®, etc.) at a top-level. In the figure, manufactures are abbreviated as ‘MU’. The categorization interface 236 may receive an input of manufacturers from an administrator. Alternatively, the categorization interface 236 may access one or more electronic business directories to determine manufacturers. The categorization interface 236 is configured to organize brands in a next level down from the manufacturers. Each manufacturer may have one or more brands. For example, in the United States, General Motors® owns the Chevrolet® brand, the Cadillac® brand, the GMC® brand, and the Buick® brand, among other brands that are discontinued. The categorization interface 236 provides the products at a sub-level or lower level from the brand. Using the General Motors® example, the Buick® includes, for example, the Verano™ product, the Regal™ product, the Enclave™ product, and the LaCrosse™ product. The categorization interface 236 is configured to search manufacturer, marketing, manufacturer webpages, and/or other business directories to determine each of the brands and/or products for the manufactures. In some instances, the categorization interface 236 is configured to enable manual specification of the brands and/or products.

After determining the manufacturer, brand, and product of an advertisement, the example categorization engine 238 is configured to determine whether the advertisement is associated with an advertising campaign. As shown in FIG. 7, advertising campaigns (abbreviated as ‘CAMP’) are linked or otherwise associated with the appropriate product. It should be appreciated that some campaigns may span multiple products of the same brand or different brands of the same manufacturer. The categorization engine 238 is configured to compare the advertisement information (or campaign information) of each of the campaigns under the product to the advertisement information of the advertisement under categorization. For example, the categorization engine 238 may compare target URLs to determine if the advertisement is part of the campaign since some companies create specific landing webpages dedicated to the campaign. In other instances, the categorization engine 238 is configured to match slogans, characters, themes, or any other information that can be determined and stored as advertisement information. If there is a match, the categorization engine 238 adds the advertisement to the campaign (if the advertisement has not already been added). For example, in FIG. 7, the campaign IV has five associated advertisements (AD i to AD v). The ads may include a mix of video, display, and animation ads.

If there is not a match, the categorization engine 238 is configured to create a new campaign under the product. Creating a campaign may include determining a name and/or campaign identifier. Creating a campaign may also include determining common characteristics of the campaign including selecting from the advertisement information, character information, theme information, a slogan, target URL, etc.

It should be appreciated that the categorization interface 236 and categorization engine 238 provides a framework for automatically classifying advertisements into corresponding campaigns. This enables the monitoring server 204 to reconstruct how a company designs and promotes an advertising campaign without having any contact with the company. The classification and campaign construction is instead determined based on panelists that view the advertisements through webpages and other digital domains. Creating advertising campaigns in this manner enables the monitoring server 204, as discussed in more detail below, to determine the effectiveness of each advertisement within a campaign and ultimately, determine how many (and/or which types of) users (extrapolated from panelists) most likely viewed a campaign and which websites generated the most views for a campaign.

### Real User Determination Embodiment

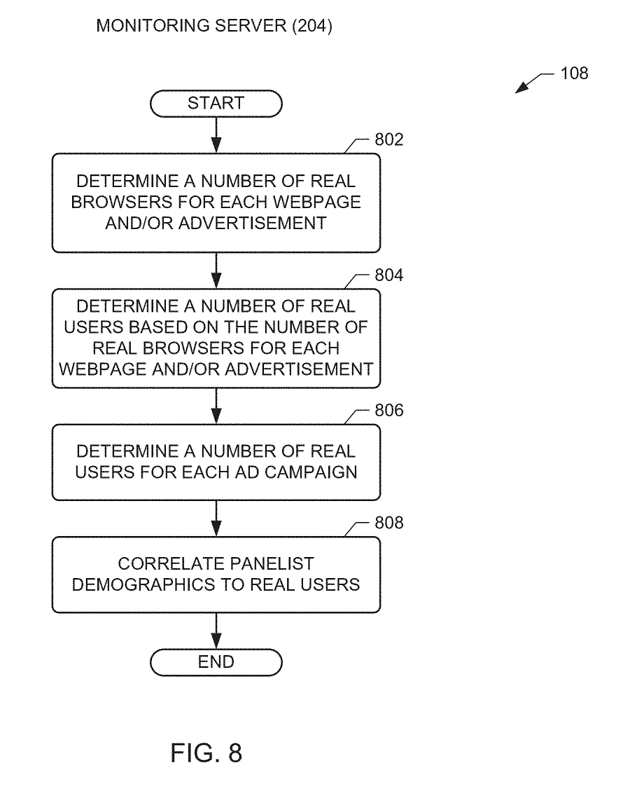

The example ad campaign monitoring server 204 of FIG. 2 includes a user analysis engine 240 configured to estimate or determine a number of real users that have viewed a particular advertising campaign, specific advertisements, and/or webpages, as mentioned above in connection with step 108 of the procedure 100 of FIG. 1. FIG. 8 shows a diagram of steps the analysis engine 240 of the monitoring server 204 may be configured to execute (of procedure 108) to determine a number of real users for each advertising campaign, advertisement, and/or website, according to an example embodiment of the present disclosure.

Although the procedure 108 is described with reference to the flow diagram illustrated in FIG. 8, it should be appreciated that many other methods of performing the steps associated with the procedure 108 may be used. For example, the order of many of the blocks may be changed, certain blocks may be combined with other blocks, and many of the blocks described are optional. For instance, the procedure 108 may execute separate threads to determine real users of advertising campaigns, individual advertisements, and websites.

Reference is made herein to real users and real browsers. Occasionally, log files 318 and/or cookies may include data that misrepresents web browsing activity. For example, some panelists may accidently type a website name, select a wrong website, or select a link that redirects to an unexpected webpage. In other examples, panelists may use certain browsers infrequently so as not be a reliable source of browsing activity. Further, some panelist devices 202 may include malware configured to access certain websites for different types of attacks (such as distributed denial of service attacks) when panelists are not present. The monitoring application 208 may record this activity, which is interpreted as panelist activity. To account for at least some of these scenarios, the user analysis engine 240 is configured to determine a number of real browsers and real users.

Real browsers are web browsers that are determined to be frequently and consistently used by panelists. For example, some panelists may use two different browsers, each with the monitoring application 208 installed. The first browser may be used for visiting discreet websites, and used only at certain times during evenings while the second browser is used for all other occasions. The user analysis engine 240 is configured to determine that data from only the second browser is indicative of consistent panelist behavior. The user analysis engine 240 is configured to use a ratio of real browsers to total browsers to determine or estimate a number of real users that viewed the website and/or viewed advertisements of a campaign. Real users are accordingly estimated users of a population of a defined area that have accessed a certain website or viewed certain advertisements. Demographics of the panelists that viewed the same websites and/or advertisements may be extrapolated to the real users.

### I. Real Browser Determination Embodiment

The example procedure 108 of FIG. 8 begins when the user analysis engine 240 determines a number of real browsers using the advertisement information within the ad files 600 and/or browser cookies received from the monitoring application 208 (block 802). There are a number of different ways that real browsers may be determined. For example, an estimated cookies approach may be used to takes into account how often a website is accessed. It should be appreciated that the date/time advertisement information may be used instead of cookies.

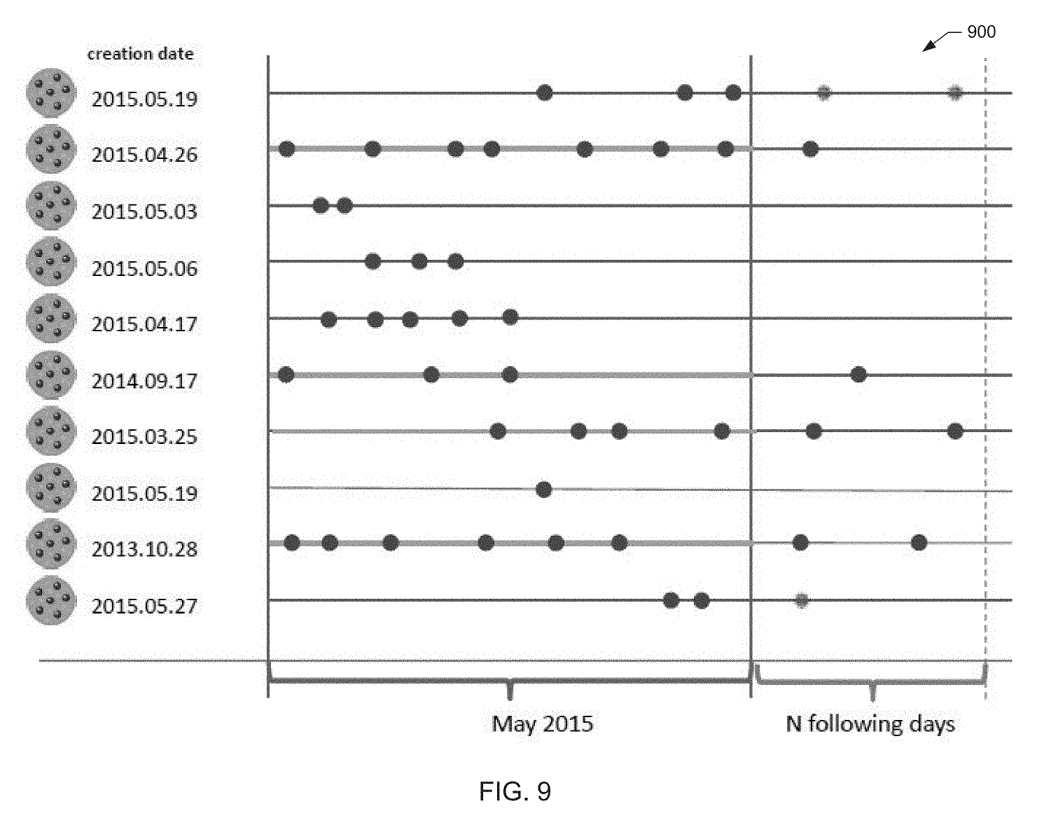

FIG. 9 shows a diagram of estimated cookie (“EC”) data 900 for May 2015 for a specific website (or webpage). The creation date corresponds to a date the cookie was created. Each cookie corresponds to a different panelist. The points on each timeline correspond to a time that the particular website was accessed. As mentioned, the date/time advertisement information may be used instead to determine the points on each timeline. Under the EC approach, real browsers are determined using the following equation:

$$\frac{Real Browsers}{All Page Views} = \frac{Target Browsers}{Target Page Views} \qquad ( 1 )$$

The target browsers are identified based on the points in the timeline shown in FIG. 9. For instance, for a web browser to be labeled as a target, the corresponding cookie would have to have been created before the month started, exist until the end of the month, and generate at least one page view after the month ends. In this example, the cookies with creation dates of Apr. 26, 2015, Apr. 17, 2015, Sep. 17, 2015, Mar. 25, 2015, and Oct. 28, 2013 satisfy those rules and are accordingly identified as target browsers. The target page views correspond to the total number of page views for the target browsers for the month. In this illustrated example, there are 20 target page views for the four target browsers. The all page views value corresponds to the total number of page views for all of the cookies shown in FIG. 9. In this example, there are a total of 36 pages views during May 2015. The real browser number can be determined as the four target browsers divided by 20 target page views, multiplied by the 36 total page views, which is equal to 7.2 real browsers. In other words, the ratio of target browsers to page views is approximately equal to the ratio of real browsers for all page views.

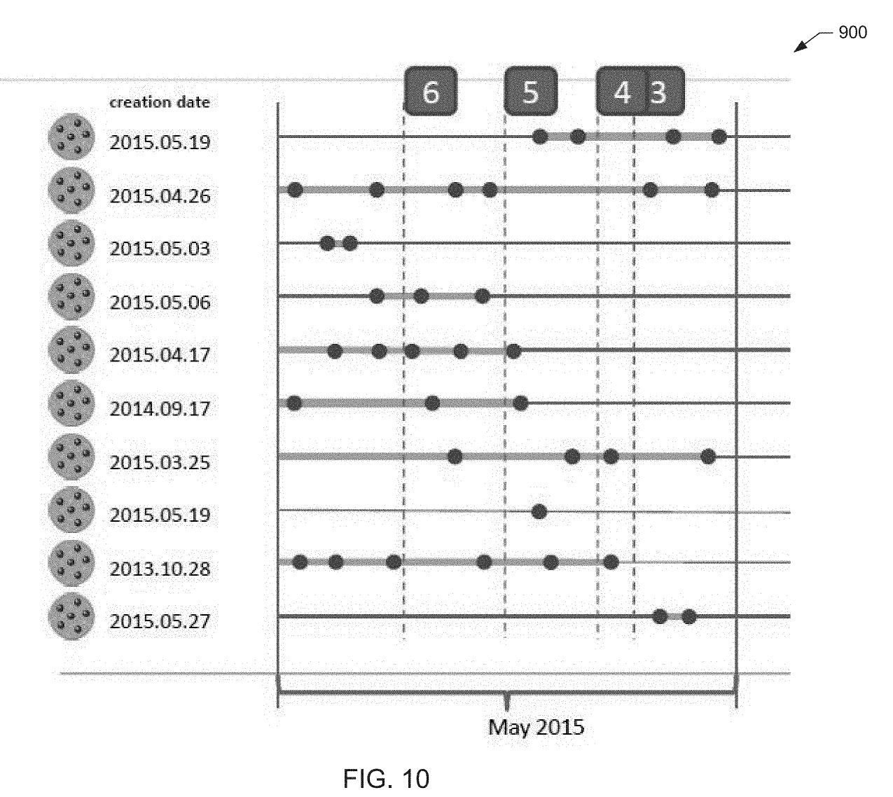

Another approach for determining real browsers is referred to as Lower Bound of Users (“LBU”). FIG. 10 shows a diagram of an LBU analysis performed by the user analysis engine 240 using the same cookie data discussed in connection with FIG. 9. In this example, the user analysis engine 240 is configured to determine a minimum number of active web browsers needed to generate the traffic shown in FIG. 10. In other words, the user analysis engine 240 is configured to determine the greatest number of web browsers that were active at any one moment during May 2015. FIG. 10 shows examples of different numbers of web browsers needed to generate the identified traffic during different times in May 2015. As shown, six different web browsers were needed at most during the month to generate that traffic. The number of real browsers is accordingly set as six. It should be appreciated this this LBU method is less precise than the EC method but may provide more timely results.

A third approach for determining real browsers is referred to as Browser Estimation Algorithm Standard (“BEAST”). Under this approach, the user analysis engine 240 is configured to calculate a probability of whether each browser is a real browser. The probability is based on two components. A first component (‘T1’) takes into account an amount of time elapsed from last noted activity in a month to the end of the month, expressed in a number of calendar days. Thus, if the last noted activity in May 2015 was May 23, 2015, the first component would have a value of ‘8’. The second component (‘T2’) takes into an account the activity rate of the cookie in a predetermined time period (e.g., four weeks) preceding the last noted activity, also expressed in calendar days. In other words, the second component represents the number of days, within the past four weeks, in which the website was accessed.

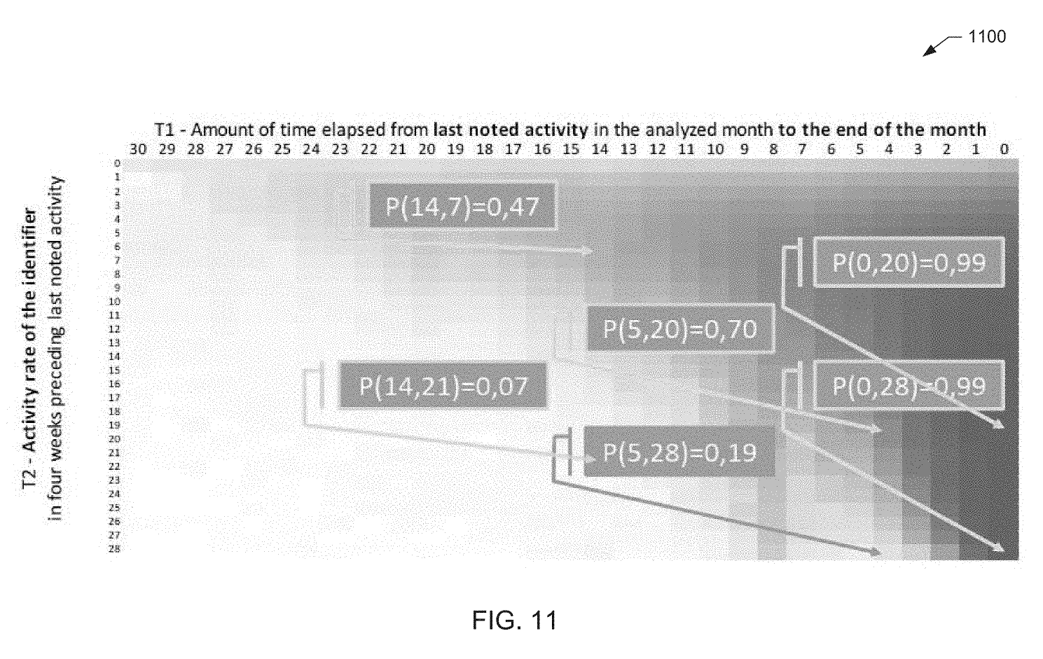

FIG. 11 shows a diagram of an example probability matrix 1100 used by the user analysis engine 240 to determine the probability that a browser is a target browser. The darker-shaded areas correspond to regions of relatively higher probability. It should be appreciated that the probability matrix 1100 is just one example of how a probability value can be generated from the two components. As shown in FIG. 11, higher probability values corresponds to more frequent use of the web browser and less elapsed time from the end of the month.

The example user analysis engine 240 is configured to use equation (2) below to sum the probability of each browser to determine the number of target browsers. A probability may be determined for each browser. Alternatively, the probability may only be determined for good browsers as identified using the EC approach. Additionally, the example user analysis engine 240 is configured to use equation (3) below to sum the probability of each page view of a target browser to determine the number of target page views.

$$\begin{matrix}Target Browsers = {\sum }_{T 1 = 0}^{30} {\sum }_{T 2 = 0}^{28} Probability ( T 1 , T 2 ) * Browser ( W , T 1 , T 2 ) & ( 2 ) \\ Target Page Views = {\sum }_{T 1 = 0}^{30} {\sum }_{T 2 = 0}^{28} Probability ( T 1 , T 2 ) * Page Views ( W , T 1 , T 2 ) & ( 3 )\end{matrix}$$

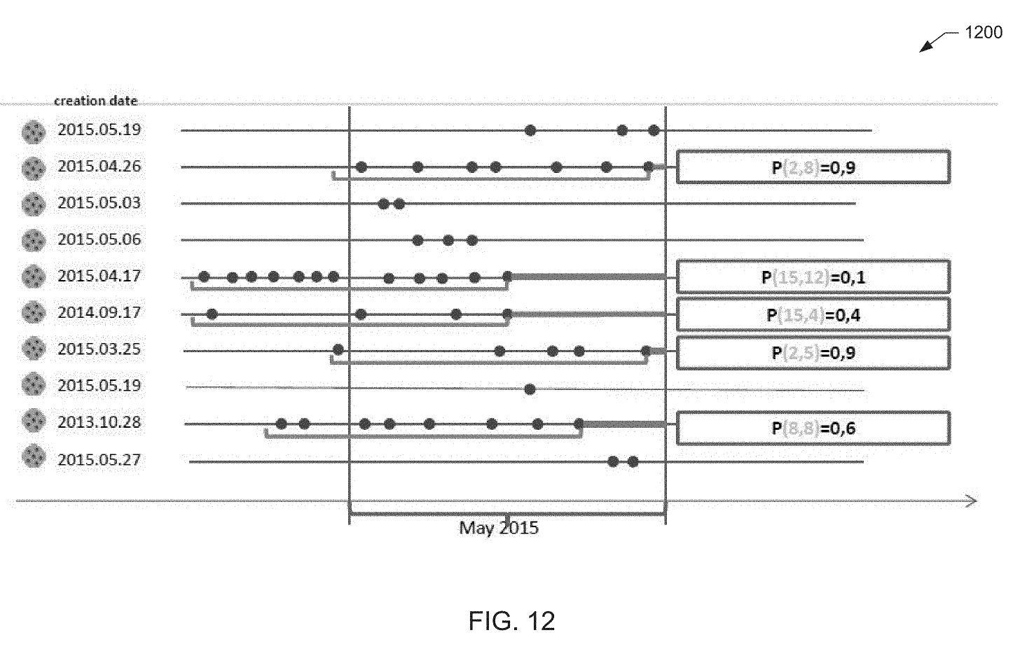

FIG. 12 shows a diagram of an example BEAST calculation that may be performed by the user analysis engine 240. In this example, the user analysis engine 240 first identifies target browsers (Browser W) that have cookies that existed before the start of May 2015. For each of these target browsers, the user analysis engine 240 determines the first and second components (T1, T2). The user analysis engine 240 then applies T1 and T2 to the probability matrix 1100 of FIG. 11 to determine the probability of the browser being a target browser. The total number of target browsers is determined as a sum of the individual probabilities. In this example, there would be a total of 2.9 target browsers. It should be appreciated that the user analysis engine 240 may determine the probability for all of the browsers. However, the resulting relatively low probability would have minimal affects on the determined number of target browsers.

The user analysis engine 240 determines the number of target page views by multiplying the number of page views for each target browser during the month by the probability for that browser. For example, the browser associated with the Apr. 26, 2015 cookie has seven page views during May 2015. These seven page views are multiplied by the 0.9 probability to generate a value of 0.63 page views. The page views for each target browser are summed to determine a total number of target page views. Using equation (1) above (with 2.9 target browsers and 15.2 target page views), the user analysis engine 240 determines that there are approximately 6.87 real browsers for this particular website during May 2015.

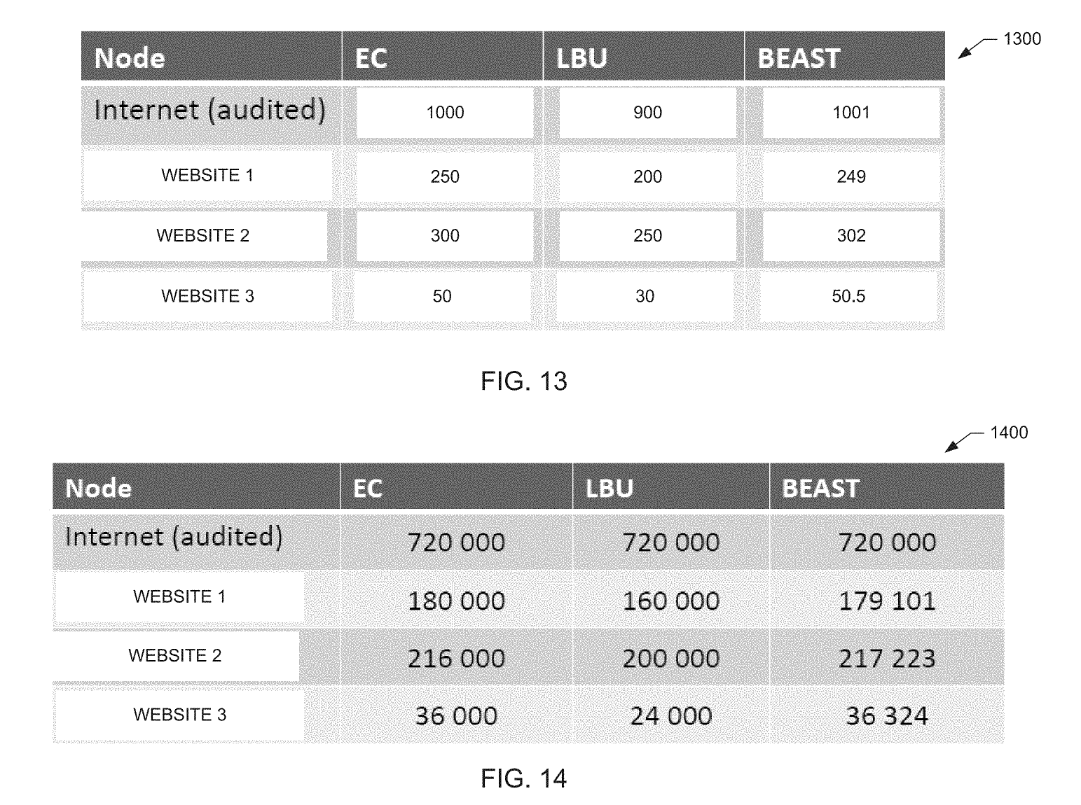

FIG. 13 shows a diagram of a chart 1300 of real browsers of panelists determined by the user analysis engine 240 for the Interest in general and different websites using the EC, LBU, and BEAST approaches discussed above. In this example, approximately 1000 real browsers accessed the Internet. Of these browsers, approximately 250 accessed Website 1, 300 accessed Website 2, and 50 accessed Website 3. Such data provides information on proportions of access among panelists.

It should be appreciated that the user analysis engine 240 may use similar processing to determine the number of real browsers for each advertisement or ad campaign. Instead of using cookie data, the user analysis engine 240 may chart how often a particular advertisement (or advertisements of a campaign) was viewed during a specified time period. The chart may consider the specific advertisement (or campaign) on one website, a set of websites, or all available websites. In this example, each timeline of the chart would correspond to a different user. The user analysis engine 240 determines the number of real browsers for that advertisement (or campaign) using the same approaches as discussed above.

### II. Real User Determination Embodiment

The example user analysis engine 240 is configured to determine a number of real users based on the number of real browsers (block 804 of FIG. 8). To make the determination, the user analysis engine 240 determines a total Internet population for a given region as well as a study reach. The total Internet population may be known from previous research or tracking. For example, it may generally be known that Region A has a total approximate Internet population of 900,000 people. The study reach corresponds to users of the population who have visited at least one audited website within a month or viewed an audited ad. The study reach may be determined from a sampling of the panelists and/or provided via other tracking methods. For instance, the user analysis engine 240 may determine that 90% of the panelists accessed the Internet during the specified month, which provides a reach value of 0.90. Accordingly, the study reach for the total population is approximated at 720,000 people.

The real users for each website is determined by multiplying the study reach of the total population by the ratio of the website access compared to the Internet in general, as shown in FIG. 13. For example, for Website 1, the number of real users is determined by multiplying 720,000 people by the reach of Website 1, which is 250 panelists divided by 1000 panelists (i.e., 180,000 people). In other words, the number of real users is estimated based on the proportion of panelists in the panelist population that accessed the given website. FIG. 14 shows a diagram of a chart of a number of real users for each of the websites using the different approaches. In this illustrated example, the user analysis engine 240 determines that approximately 180,000 real people visited Website 1, 216,000 real people visited Website 2, and 36,000 real people visited Website 3 during May 2015.

It should be appreciated that the user analysis engine 240 may perform a similar calculation for each advertisement. For example, the user analysis engine 240 may multiple a proportion of real browsers for each advertisement in relation to total Internet access by the total population study range (i.e., 720,000) to determine a number of real users for that advertisement. The real users for each advertisement may further be partitioned by certain websites that displayed the advertisements.

### III. Ad Campaign Real User Determination Embodiment

After determining the number of real users, the example user analysis engine 240 of FIG. 2 is configured to determine a number of real users for each advertising campaign (block 806 of FIG. 8). In the instance where real users for website are determined, the user analysis engine 240 is configured to determine from the advertisement information within the ad file 600 which advertisements were displayed on each website during the time period under analysis. In addition, the user analysis engine 240 is configured to determine a portion of time each advertisement was displayed by, for example, comparing a number of times different ads were displayed in the same designated location on a webpage. The user analysis engine 240 multiplies the number of real users for the website by the portion of time the advertisement was displayed to estimate the number of real users that viewed each advertisement.

In other examples, as discussed above, the user analysis engine 240 is configured to use the panelist information to determine a number of real browsers for each advertisement. The user analysis engine 240 then determines a proportion of real browsers for each advertisement in relation to the number of real browsers accessing the Internet. The user analysis engine 240 multiples the proportion by the study reach population to determine the number of real users for the advertisement.

Under either approach, the user analysis engine 240 is configured to determine the number of real users for an advertising campaign by combining each of the advertisements associated with the same campaign. It should be appreciated that this total number is not additive for each advertisement since some users most likely viewed more than one advertisement of a campaign. To determine the number of real users for a campaign, the user analysis engine 240 accesses the hierarchal tree 700 of FIG. 7 to determine which advertisements are part of the same campaign. The user analysis engine 240 then determines the number of real browsers that viewed each advertisement in the campaign. The user analysis engine 240 also determines a number of real browsers that viewed more than one advertisement. For example, the user analysis engine 240 may calculate a probability that each real browser viewed each advertisement, and combine the probabilities to a number of unique real browsers for the advertisement campaign.

Additionally or alternatively, the user analysis engine 240 may count how many real browsers viewed at least one advertisement of a campaign. The total count of real browsers corresponds to how many panelists viewed at least one advertisement of the campaign. The user analysis engine 240 determines a proportion of the real browsers for the campaign to a total number of real browsers accessing the Internet. The user analysis engine 240 multiplies this proportion by the study reach population to determine a number of real users that viewed the campaign.

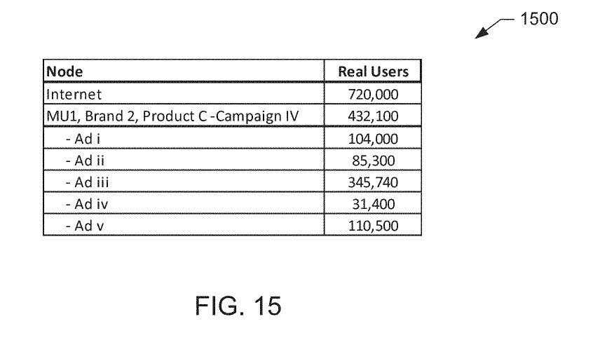

FIG. 15 shows a diagram of an example chart 1500 that shows a number of real users for an advertising campaign, as determined by the user analysis engine 240. In this example, the study reach of the population is 720,000. Additionally, the user analysis engine 240 determines a number of real users for each of the individual advertisements associated with a particular campaign, as organized by the hierarchal tree 700. The user analysis engine 240 also determines a number of real users that viewed at least one advertisement of the campaign, displayed as total real users of the campaign. To determine total unique users, the user analysis engine 240 may create a list of panelists (or real browsers) that viewed each of the advertisements. The engine 240 then removes reoccurring instances of the same panelists (or real browsers) that viewed multiple advertisements. The user analysis engine 240 then counts the number of panelists (or real browsers) and extrapolates this value to a number of real users based on a portion of panelists (or real browsers) to a total number of panelists (or real browsers) that accessed the Internet. The real user information enables third-parties to determine which advertisements of a campaign were effective at reaching people and promoting the message. Such information also provides valuable information regarding how many different people were exposed to an advertising campaign, which includes multiple advertisements displayed across scores of websites and other digital forums.

### IV. Ad Campaign Real User Demographics Determination Embodiment

The example user analysis engine 240 of FIG. 2 is also configured to determine approximate demographics of the real users for the advertising campaigns, advertisements, and/or websites (block 808 of FIG. 8). To determine the approximate demographic composition of the real users, the user analysis engine 240 correlates each advertisement and/or website viewing recorded by the monitoring applications 208 to the corresponding panelists. As mentioned above, the database 210 is configured to store demographic information of panelists. Additionally, the user analysis engine 240 uses the ad file 600 of FIG. 6 to correlate panelists to advertisements viewed and/or websites visited, as determined from browsing and advertisement information (including browser cookies). The user analysis engine 240 determines, for example, a demographic profile for each advertisement, campaign, or website by summing the demographics for one or more specific demographic categories for each of the related panelists. For each demographic category, the user analysis engine 240 is configured to create ratios of the different demographic attributes based on the number of panelists that have those attributes. For example, the user analysis engine 240 may determine that of the 250 panelists (which may correspond to real browser) that viewed a certain advertisement, 55% were male and 45% were female. The demographic profile of the advertisement would accordingly include a 55/45 male to female ratio. It should be appreciated that similar ratios can be determined for other demographic categories including, for example, race, age, income level, and geographic location.

After determining a demographic profile for each advertisement, campaign, or website, the user analysis engine 240 applies that profile to the number of real users and stores this correlation within the database 234. In this embodiment, it is assumed that the profile of real users approximates the profile of panelists. However, certain weights may be used to adjust profiles when known biases or skews exist among the panelists. Using the example from above, the user analysis engine 240 determined that 104,000 real users viewed ‘advertisement i’, as shown in FIG. 15. The user analysis engine 240 applies the 55/45 ratio of the demographic profile of the advertisement to estimate that 57,200 of the real users were male and 46,800 of the real users were female. Such a breakdown is possible for virtually any demographic trait.

It should be appreciated that such a configuration enables the monitoring system 104 to show estimated or approximate demographic traits of the real users that viewed an advertising campaign, individual advertisement, and/or website. In some instances, the user analysis engine 240 may determine cross-correlations to show demographic profiles of real users for each advertisement across different websites. The user analysis engine 240 may also determine demographic profiles of the different web sites and determine if there is a correlation with regard to profiles of real users of a website in general versus profiles of users that viewed (or even interacted with) certain advertisements on the website. For instance, the user analysis engine 240 may determine that while a majority of website real users were women, a certain advertisement displayed on the website was viewed by males. Such a scenario could be a result of advertisement selection using cookie data or other identifying information.

### Graphical Display of Real User Statistics Embodiment

After estimating the demographic profiles of real users for websites, advertisements, or more generally advertising campaigns, the example procedure 108 of FIG. 8 ends. The example monitoring system 204 is configured to provide a graphical representation of the estimated real user information, as mentioned above in connection with step 110 of the procedure 100 of FIG. 1. To provide the graphical representation, the monitoring server 204 includes a display interface 242.

The example display interface 242 is configured to enable third-parties to specify how data is to be displayed and/or presented in a user interface. For instance, the display interface 242 is configured to enable third-parties to select certain criteria and filter certain characteristics to determine an effectiveness or reach of advertisements, advertising campaigns, and/or websites. For instance, the display interface 242 may enable third-parties to view data based on a time periods (e.g., daily, weekly, monthly, etc.), hierarchical tree, industry relationships, publisher, website, ad network, ad type, sales model, etc. The example display interface 242 is configured to display data in different metrics or units including, for example, panelists, real users, impressions, in-screen time, on-screen rate, real impact, click-throughs, etc.

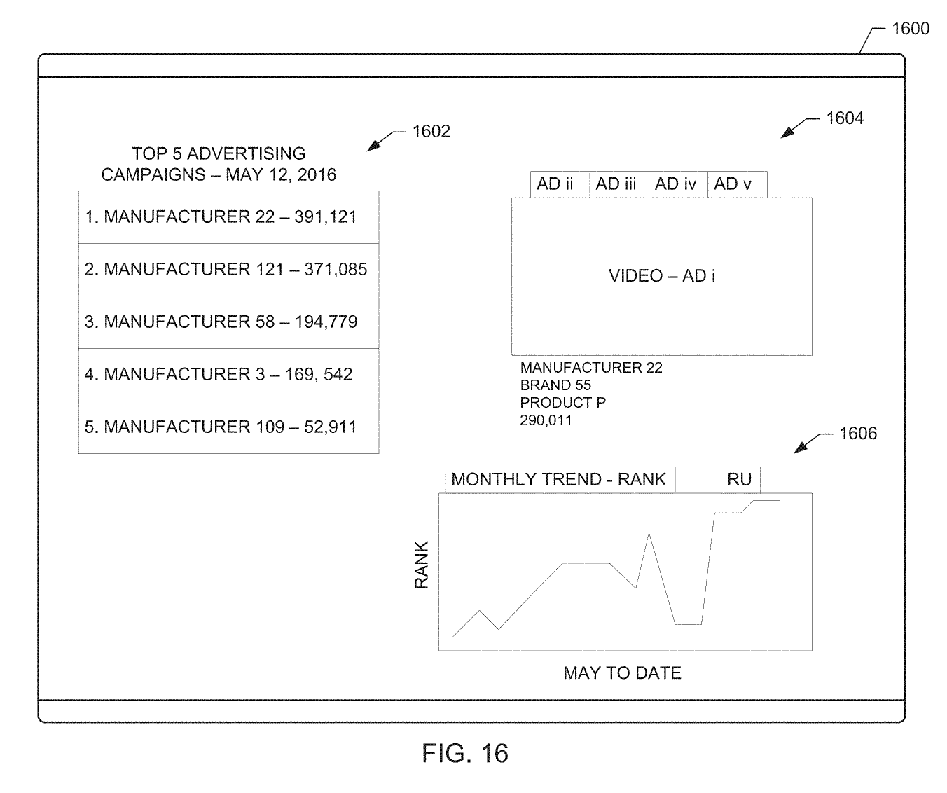

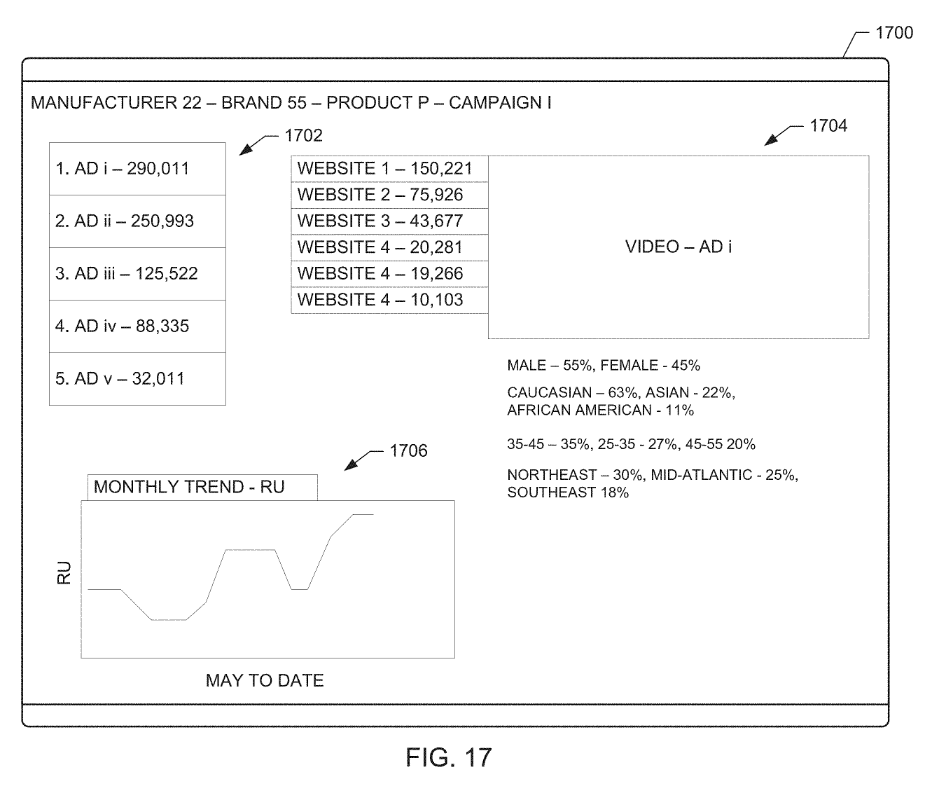

FIGS. 16 and 17 show diagrams of user interfaces displayed by the example display interface 242 of FIG. 2, according to example embodiments of the present disclosure. Specifically, FIG. 16 shows a diagram of a user interface 1600 that is provided by the display interface 242 to a third-party device. The user interface 1600 provides a summary of top advertising campaigns for a defined geographic region, such as the United States or Poland. For instance, the user interface 1600 includes a ranking section 1602 that shows the top five advertising campaigns by real users.

The user interface 1600 also includes a display section 1604 configured to display advertisements of a selected campaign. As illustrated, the interface 1600 includes a video player within the display section 1604 configured to play the creative file (stored in the database 230). The display section 1604 also lists the other advertisements within the campaign that may be individually selected to view the advertisement. The display section 1604 also includes information related to the advertisement including, for example, manufacturer, brand, and product information (as stored in the ad file 600) and a number of real users that viewed the advertisement.

The user interface 1600 also includes a graph section 1606 this is configured to show a rank of the selected advertising campaign in relation to other campaigns over a specified time period (e.g., one month). The graph section 1606 also includes a section (‘RU’) that would change the displayed graph to number of real users for the month. It should be appreciated that the data displayed within the sections 1602, 1604, and 1606 is only illustrative of the potentially infinite ways that information about advertising campaigns can be displayed. Further, while the user interface 1600 is directed to advertising campaigns, in other embodiments the interface could be directed to individual advertisements and/or websites. For example, the ranking section 1602 may display the top ten advertisements for a given day.

FIG. 17 shows a diagram of a user interface 1700 configured by the display interface 242 to display specific information about a selected advertising campaign (e.g., Campaign I for Product P). In this illustrated example, the user interface 1700 includes a ranking section of the individual advertisements associated with the advertising campaign. The user interface 1700 also includes an ad section 1704 configured to display information about the particular advertisement. Such information may include, for example, top websites that displayed the advertisement (partitioned by real users), a demographic profile of the advertisement, a type of advertisement, a publisher of the advertisement, emission information, etc.

The user interface 1700 also includes a graph section 1700 configured to display the popularity of each advertisement of the campaign over a defined time period. In some instances, the graph section 1700 may display all advertisements on one graph to shown when certain advertisements of the campaign were popular. Further, the graph section 1700 may provide breakdowns of real users my demographics or other specified criteria.

It should be appreciated from the above disclosure that the example monitoring server 204 is uniquely configured to provide information regarding the effectiveness of advertising campaigns. Through the determination of advertisement information, the monitoring server 204 is able to extrapolate panelist data to entire populations while being able to correlate demographic information down to individual advertisements and/or websites. Such a configuration enables campaign creators to determine if their advertisements, or campaigns in general, reached the intended audiences. This is especially unique with regard to campaigns, where it is generally difficult to determine which advertisements are part of a campaign, let alone, how effective the advertisement was with respect to other advertisements within the campaign. Such information also enables website operators and ad-resellers to set pricing based on real user data.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An advertisement campaign analysis apparatus comprising:
a categorization interface connected to panelist devices and ad servers, the categorization interface configured to:
receive, from monitoring applications operating on a browser of each of the panelist devices, log files that include copied portions of website code related to advertisements, the monitoring application configured to use at least one advertisement identification rule to identify the advertisements on websites,
analyze the copied website code for addresses of ad servers associated with the advertisements, and
access the ad servers to obtain copies of creative files associated with the advertisements;
a categorization processor communicatively coupled to the categorization interface and configured to:
determine advertisement information associated with each of the creative files,
determine a product associated with each of the creative files using at least some of the copied website code and the corresponding advertisement information, and
determine, for each creative file, an advertising campaign for the determined product using at least some of the copied website code and the corresponding advertisement information;
a user analysis engine configured to determine a number of real users that viewed each of the advertising campaigns by determining a number of real users that viewed each advertisement within the advertising campaign based on a number of instances each advertisement was viewed by the panelists; and
a display interface configured to display the number of real users that viewed the advertising campaigns.

2. The apparatus of claim 1, wherein the categorization interface is configured to determine which advertisements are part of the same campaign by matching landing webpages included within the advertisement information.

3. The apparatus of claim 1, wherein the categorization interface is configured to determine the advertisement information by at least one of reading metadata of the related creative file, comparing audio of the related creative file to audio signatures, converting audio into searchable text, and performing image recognition of video or display advertisements.

4. The apparatus of claim 1, wherein the categorization interface is configured to use at least one of the advertisement information, the copied website code, and the creative files to:
determine a manufacturer and a brand for each of the products; and
create a hierarchical tree where each manufacturer is located at a first level, brands of the manufacturer are located at a second level, products of the brands are located at a third level, and advertising campaigns of the products are located at a fourth level.

5. The apparatus of claim 1, wherein the user analysis engine is configured to determine the number of real users for each of the advertisements by:
determining a number of real browsers that displayed each of the advertisements using the number of instances each advertisement was viewed by the panelists;
determining a proportion of real browsers for each advertisement to a number of real browsers that accessed the Internet;
determining a number of study users based on a study reach of a population of a defined area; and
multiplying each proportion by the number of study users to determine the number of real users for the respective advertisement.

6. The apparatus of claim 5, wherein the user analysis engine is configured to determine the number of real browsers using at least one of an estimated cookies method, a lower bound of users method, and a browser estimation algorithm standard method.

7. The apparatus of claim 1, wherein the user analysis engine is configured to:
determine a demographic profile for each of the advertisements based on demographic profiles of panelists that viewed each of the advertisements; and
apply the respective demographic profile to the number of real users for the corresponding advertisement.

8. The apparatus of claim 7, wherein the display interface is configured to display demographic profile of each advertisement in connection with the number of real users.

9. The apparatus of claim 1, wherein log files include information indicative of when panelists accessed websites, and
wherein the user analysis engine is configured to determine the number of real users for each website by:
determining a number of real browsers that accessed each of the websites using the number of instances each website was accessed by the panelists;
determining a proportion of real browsers for each website to a number of real browsers that accessed the Internet;
determining a number of study users based on a study reach of a population of a defined area; and
multiplying each proportion by the number of study users to determine the number of real users for the respective website.

10. The apparatus of claim 1, wherein the advertisement information includes at least one of a publisher of the advertisement, a first publication date of the advertisement, a brand associated with the advertisement, a product associated with the advertisement, and a manufacturer associated with the advertisement.

11. An application monitoring apparatus operating in relation to a web browser on a panelist device, the apparatus comprising:
a database comprising advertisement identification rules configured to identify advertisements within webpage code, the rules including at least one of a cascading style sheet rule, a uniform resource locator (“URL”) match rule, and an application program interface (“API”) jquery rule;
a browser interface configured to:
analyze webpages accessed by a browser and apply the advertisement identification rules to determine website code that is associated with the advertisement,
conditioned upon detecting an advertisement, copy a portion of the website code that is associated with the advertisement including a creative file source of the advertisement,
store the copied website code to a log file, and
transmit the log file to a monitoring system.

12. The apparatus of claim 11, wherein the browser interface is configured to:
determine at least one of advertisement information and browsing information related to the detected advertisement; and
store the determined at least one of advertisement information and browsing information to the log file.

13. The apparatus of claim 12, wherein the advertisement information includes at least one of a mediaplan of a video advertisement, a creative file source of the advertisement, advertisement emission information, advertisement website placement information, publisher information, an advertisement identifier, advertisement in-screen time, advertisement panelist interaction information, a target landing webpage of the advertisement, and a date/time the advertisement was viewed.

14. The apparatus of claim 12, wherein the monitoring application is at least one of a plug-in to the web browser, an add-in to the web browser, an extension of the web browser, and a standalone application.

15. The apparatus of claim 12, wherein the advertisement includes at least one of a display advertisement, a video advertisement, a search advertisement, a social media advertisement, and a rich media advertisement.

16. A monitoring server apparatus comprising:
a categorization engine configured to manage a hierarchical tree that relates manufacturers to brands, brands to products, products to advertising campaigns, and advertising campaigns to advertisements;
a database configured to store advertisement information and creative files for the advertisements, the advertisement information including dates panelists have viewed the advertisements; and
a user analysis engine configured to, for each advertisement within an advertising campaign:
create a timeline for each panelist browser that viewed a particular advertisement during a specified time period, the timeline showing each time the advertisement was viewed during the specified time period by that panelist,
determine a number of real browsers that viewed the particular advertisement based on the timelines,
determine a proportion of real browsers for the particular advertisement to a number of real browsers that accessed the Internet,
determine a number of study users based on a study reach of a population of a defined area,
determine the number of real users of the population that viewed the particular advertisement by multiplying the proportion by the number of study users, and
determine a number of the real users of the advertising campaign as a portion of the real users that viewed the particular advertisement; and
a display interface configured to display the number of real users for the advertising campaign.

17. The apparatus of claim 16, wherein the user analysis engine is configured to determine the number of real browsers by:
determining a probability for each of the panelist browsers based on a probability matrix that relates a number of days the browser displayed the advertisement within a second time period and a number of days between the last view of the advertisement and the end of the specified time period;
determining a ratio of a sum the probability for each of the panelist browsers to a sum of the number of times the advertisement was viewed; and
determine the number of real browsers by multiplying the ratio by the total number of times the advertisement was viewed by all panelists.

18. The apparatus of claim 16, wherein the user analysis engine configured to, for each website:
create a timeline for each panelist browser that viewed a particular website during a specified time period, the timeline showing each time the website was viewed during the specified time period by that panelist;
determine a number of real browsers that viewed the website based on the timelines;
determine a second proportion of real browsers for the website to a number of real browsers that accessed the Internet; and
determine the number of real users of the population that visited the website by multiplying the second proportion by the number of study users.

19. The apparatus of claim 16, wherein the user analysis engine configured to determine the number of the real users of the advertising campaign by:
compiling a list of all of target browsers for the advertisements of the advertising campaign;
removing from the reoccurrences of the same target browsers;
summing the total number of target browsers on the list; and
determining the number of the real users of the advertising campaign based on the summed total number of target browsers on the list.

20. The apparatus of claim 16, wherein the display interface is configured to display the number of real users for the advertising campaign in relation to a number of real users for other advertising campaigns.
